(19) United States
(12) Patent Application Publication
(10) Pub. No.: US 2025/0341312 A1
(43) Pub. Date: Nov. 6, 2025

(54) DESIGN METHOD FOR AXIAL MULTI-STAGE COMBUSTOR AND AXIAL MULTI-STAGE COMBUSTOR APPLYING THE SAME METHOD

(71) Applicant: KOREA ADVANCED INSTITUTE OF SCIENCE AND TECHNOLOGY, Daejeon (KR)

(72) Inventors: Kyu Tae KIM, Daejeon (KR); Gyeonghyun HAN, Daejeon (KR); YONGSEOK CHOI, Daejeon (KR)

(21) Appl. No.: 18/965,510

(22) Filed: Dec. 2, 2024

(30) Foreign Application Priority Data
May 2, 2024 (KR) 10-2024-0058378
Aug. 29, 2024 (KR) 10-2024-0116605

(51) Int. Cl. F23R 3/42; F02C 3/14; F02C 7/22; F23R 3/28

(52) U.S. Cl. CPC F23R 3/42; F02C 3/14; F02C 7/22; F23R 3/28

(57) ABSTRACT

Provided is a method of designing a combustor including a first combustion chamber and a second combustion chamber connected in an axial direction includes defining zones of the first combustion chamber and the second combustion chamber, disposing a primary injector supplying a fuel-air mixture to the first combustion chamber, and disposing a secondary injector supplying an additional fuel-air mixture to the second combustion chamber, wherein the disposing of the secondary injector includes setting an acoustic field of the combustor, simulating a pressure fluctuation distribution within the acoustic field, and determining an arrangement position of the secondary injector based on the pressure fluctuation distribution.

### CROSS-REFERENCE TO RELATED APPLICATIONS

This application claims priority under 35 U.S.C. § 119 to: Korean Patent Application No. 10-2024-0058378, filed on May 2, 2024; and Korean Patent Application No. 10-2024-0116605, filed on Aug. 29, 2024; in the Korean Intellectual Property Office, the disclosure of which is incorporated herein by reference in its entirety for all purposes.

### TECHNICAL FIELD

The following disclosure relates to a design method for an axial multi-stage combustor having a plurality of combustion chambers in an axial direction and an axial multi-stage combustor applying the same design method.

### BACKGROUND

Gas turbine systems, which obtain energy by rotating a turbine with high-temperature and high-pressure gas generated when combusting compressed air with fuel, have been widely used as a power source for power generation or transportation, etc.

Recently, gas turbine systems have been developed as eco-friendly fuel-based systems to respond to environmental regulations, and axial multi-stage combustor systems having two or more combustion chambers in an axial direction have also been developed to reduce pollutants.

An axial multi-stage combustor is a combustor designed by dividing a fuel reaction region into a plurality of regions arranged axially from the existing single region. This may lower the temperature of an upstream combustion region to reduce the occurrence of nitrogen oxide, and at the same time, raise the temperature of a combustion region immediately before a downstream turbine entrance to contribute to increase thermal efficiency.

However, due to the increased complexity of the axial multi-stage combustor system, a combustion instability pattern is also complicated, and thus, a design of an axial multi-stage combustor that may suppress combustion instability is required.

In the related art, a combustor design method capable of suppressing combustion instability has not been suggested, so it was common to select a point at which combustion instability does not occur through repeated designs and experiments and find an operating condition under which instability does not occur among them to operate the combustor. This, however, had a problem that various variables had to be considered and a lot of time and effort had to be invested to find the optimal design, which may lead to an increase in development costs.

### Related art document

### Patent document

(Patent literature 1) Korean Application Publication No. 10-2024-0084316 (published on Jun. 13, 2024)

### SUMMARY

An exemplary embodiment of the present disclosure is directed to providing a combustor having a wide range of operating conditions.

Another exemplary embodiment of the present disclosure is directed to providing a combustor design method capable of minimizing repeated design and experiments for combustor development.

The task of the present disclosure is not limited to the tasks mentioned above, and other tasks not mentioned may be clearly understood by those skilled in the art from the description below.

In one general aspect, a design method for an axial multi-stage combustor, which is a method of designing a combustor including a first combustion chamber and a second combustion chamber connected in an axial direction, includes: defining zones of the first combustion chamber and the second combustion chamber; disposing a primary injector supplying a fuel-air mixture to the first combustion chamber; and disposing a secondary injector supplying an additional fuel-air mixture to the second combustion chamber, wherein the disposing of the secondary injector comprises: setting an acoustic field of the combustor; simulating a pressure fluctuation distribution within the acoustic field; and determining an arrangement position of the secondary injector based on the pressure fluctuation distribution.

The primary injector and the secondary injector may each include a plurality of nozzle bundles, and in the setting of the acoustic field of the combustor, the acoustic field may be set with a nozzle entrance surface of the primary injector as a front boundary surface and an axial rear end of the second combustion chamber as a rear boundary surface.

In the disposing of the primary injector, a nozzle of the primary injector may be disposed to be parallel to the axial direction of the first combustion chamber, and in the disposing of the secondary injector, a nozzle of the secondary injector may be disposed to be perpendicular to the axial direction of the second combustion chamber.

The design method may further include: checking a pressure node point in the acoustic field; and determining the arrangement position of the secondary injector as a position corresponding to the pressure node point.

The design method may further include: determining the arrangement position of the secondary injector as a point corresponding to one of pressure node points arranged at a rear end of a nozzle exit surface of the primary injector, when there are two or more pressure node points checked in the pressure distribution.

In another general aspect, an axial multi-stage combustor including a first combustion chamber and a second combustion chamber connected in an axial direction includes: a first combustion liner defining the first combustion chamber; a second combustion liner defining the second combustion chamber; a primary injector connected to the first combustion liner and supplying a fuel-air mixture to the first combustion chamber; and a secondary injector connected to the second combustion liner and supplying an additional fuel-air mixture to the second combustion chamber, wherein a position in which the secondary injector is installed in the second combustion liner is determined by an acoustic field of the combustor.

The primary injector and the secondary injector may each include a nozzle bundle including a plurality of nozzles, and the acoustic field has a nozzle entrance surface of the primary injector as a front boundary surface and an axial rear end of the second combustion chamber as a rear boundary surface.

The primary injector may be installed at a front end of the first combustion liner and a nozzle of the primary injector is disposed to be parallel to the axial direction of the first combustion liner, and the secondary injector is installed on a circumferential surface of the second combustion liner and a nozzle of the secondary injector is disposed to be perpendicular to the axial direction of the second combustion chamber.

The secondary injector may be installed at a point corresponding to a pressure node point in the acoustic field.

At least one pressure node point may be generated according to an acoustic mode of the acoustic field, and the secondary injector may be installed at a point corresponding to any one of the pressure node points located at a rear of a nozzle exit surface of the primary injector among the pressure node points.

Other features and aspects will be apparent from the following detailed description, the drawings, and the claims.

### BRIEF DESCRIPTION OF THE DRAWINGS

FIG. 1 is a schematic diagram of a combustor according to an example of the present disclosure.

FIG. 2A and FIG. 2B illustrate a cross-section taken along line A-A′ and a cross-section taken along line B-B′ of FIG. 1.

FIGS. 3, 4, and 5 illustrate an installation position of a secondary injector according to an acoustic field and an acoustic mode according to an example of the present disclosure.

FIG. 6 is a schematic diagram of a tunable combustor used in experiments and simulations.

FIG. 7 illustrates a pressure fluctuation distribution shown by simulating the tunable combustor of FIG. 6 and a pressure fluctuation distribution according to an actual experiment.

FIG. 8A, FIG. 8B, FIG. 8C, FIG. 9A, FIG. 9B, and FIG. 9C illustrate the experimental results for a combustor designed based on the simulation in FIG. 7.

### DETAILED DESCRIPTION OF EXEMPLARY EMBODIMENTS

Hereinafter, the present disclosure will be described in detail with reference to the accompanying drawings. However, this is merely an example and the present disclosure is not limited to the specific exemplary embodiments described as examples.

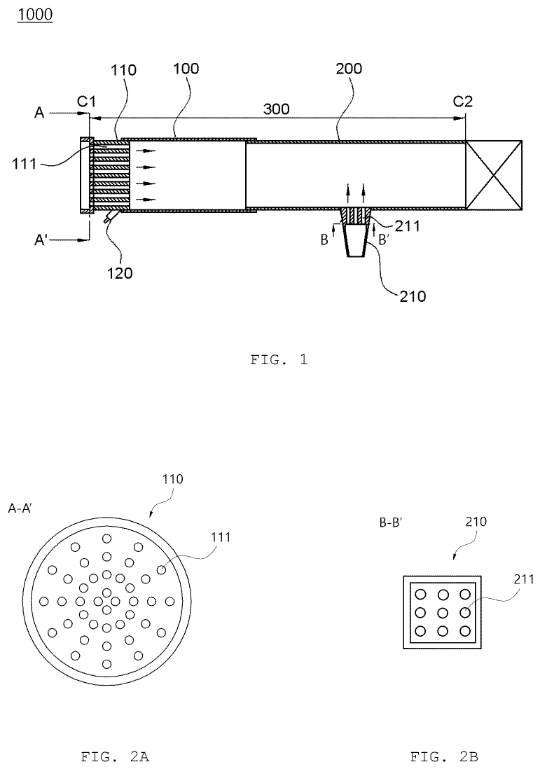

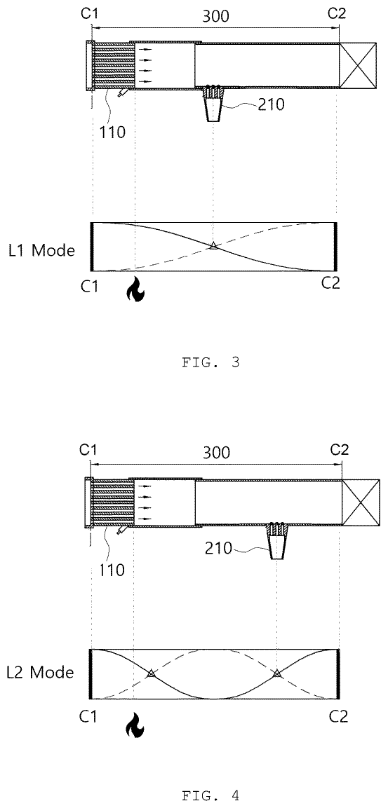

To describe more specifically, first, directions are defined. A direction corresponding to a longitudinal direction of a combustor 1000 is referred to as an axial direction, and a direction perpendicular to the axial direction and crossing the combustor 1000 is referred to as a circumferential direction. Hereinafter, the combustor 1000 of the present disclosure will be described with reference to FIGS. 1 and 2. FIG. 1 is a schematic diagram of a combustor 1000 according to an example of the present disclosure, and FIG. 2A and FIG. 2B illustrate a cross-section taken along line A-A′ and a cross-section taken along line B-B′ of FIG. 1.

The axial multi-stage combustor 1000 according to the present disclosure corresponds to a device that mixes fuel and air and produces thermal energy through a combustion process and may be mainly applied to the aerospace field, power plants and heating systems, transportation fields, etc.

The axial multi-stage combustor 1000 may form a cycle with a compressor and a turbine, and the air compressed in the compressor is injected into the combustor 1000, the combustor 1000 may generate high-temperature, high-pressure gas through a combustion process, and the turbine may convert thermal energy of the high-temperature, high-pressure gas into mechanical energy to ultimately drive a generator.

Hereinafter, a design method of an axial multi-stage combustor according to an example of the present disclosure will be specifically described. The design method for an axial multi-stage combustor according to an example of the present disclosure may include an operation of defining regions of a first combustion chamber and a second combustion chamber (S100), an operation of disposing a primary injector supplying a fuel-air mixture to the first combustion chamber (S200), and an operation of disposing a secondary injector supplying an additional fuel-air mixture to the second combustion chamber (S300), and the operation of disposing the secondary injector (S300) may include an operation of setting an acoustic field of the combustor (S310), an operation of simulating a pressure fluctuation distribution within the acoustic field (S320), and an operation of determining an arrangement position of the secondary injector based on the pressure fluctuation distribution.

The first combustion chamber may be defined by a first combustion liner 100, and the second combustion chamber may be defined by a second combustion liner 200. A primary injector 110 may be connected to the first combustion liner 100 to supply the fuel-air mixture to the first combustion chamber, and a secondary injector 210 may be connected to the second combustion liner 200 to supply the additional fuel-air mixture to the second combustion chamber. The first combustion liner 100 may include a first ignition plug 120 to ignite fuel in the first combustion chamber. In the second combustion chamber, the temperature may increase as the additional fuel-air mixture is mixed with high-temperature exhaust gas flowing out of the first combustion chamber, and autoignition may occur in this process.

The first combustion liner 100 corresponds to a body defining the first combustion chamber, and the first combustion liner 100 may have, for example, a hollow cylindrical pipe shape. The first combustion liner 100 may be formed of a heat-resistant material capable of withstanding high temperature and high pressure, and may be formed of, for example, a nickel alloy, a chromium alloy, a ceramic material, a carbon composite material, etc.

The primary injector 110 may be installed in the first combustion liner 100 to supply the fuel-air mixture to the first combustion chamber. The fuel-air mixture supplied through the primary injector 110 may be combusted in the first combustion chamber.

Meanwhile, the primary injector 110 may be formed of a plurality of nozzle bundles. FIG. 2A is a drawing illustrating an arrangement structure of a plurality of nozzle bundles in the primary injector 110, which will be described below with reference to FIG. 2A. According to an example of the present disclosure, nozzles 111 constituting the nozzle bundle of the primary injector 110 may correspond to micro-mixer type nozzles, for example, to cope with flashback that occurs when using hydrogen fuel. In addition, the nozzle bundle may correspond to a group of nozzles each having the same diameter, and each nozzle 111 may be provided to be spaced apart at a constant angular interval on a plurality of concentric circles.

In the operation of disposing the primary injector (S200), the primary injector 110 may be connected to a front end of the first combustion liner 100, and a nozzle 111 direction of the primary injector 110 may be parallel to the axial direction of the first combustion liner 100. The fuel-air mixture may be injected to be parallel to the axial direction of the combustor 1000 through the primary injector 110, so that a main flow direction of the mixed gas may be formed in the axial direction of the combustor 1000.

In addition, an outer circumferential diameter of the primary injector 110 is formed to be equal to or slightly smaller than a diameter of a front end of the first combustion liner 100, so that a portion of the primary injector 110 may be inserted into the first combustion liner 100. This may be desirable in terms of the primary injector 110 being able to stably supply the fuel-air mixture to the first combustion chamber.

The second combustion liner 200 corresponds to a body defining the second combustion chamber, and like the first combustion liner 100, the second combustion liner 200 may have a hollow cylindrical pipe shape and may be formed of a heat-resistant material. The second combustion liner 200 may be connected from the end of the first combustion liner 100 in the axial direction, so that the first combustion chamber and the second combustion chamber may be connected to each other in the axial direction.

The secondary injector 210 is installed in the second combustion liner 200 and may supply the additional fuel-air mixture to the second combustion chamber. The secondary injector 210 may also be formed of a plurality of nozzle bundles like the primary injector 110, and nozzles 211 of the secondary injector 210 may be arranged to be perpendicular to the axial direction of the second combustion chamber. That is, the secondary injector 210 may be installed on a circumferential surface of the second combustion liner 200, thereby supplying the additional fuel-air mixture in a direction perpendicular to the axial direction of the second combustion liner 200. Since the second combustion chamber is located downstream of the first combustion chamber, it may be preferable to inject the additional fuel-air mixture in the second combustion chamber in a direction perpendicular to the axial direction of the second combustion liner 200 in order to minimize a flow disturbance of the main fuel flow starting from the first combustion chamber.

FIG. 2B is a drawing illustrating an arrangement position of a plurality of nozzles 211 forming the secondary injector 210. Unlike the nozzles 111 of the primary injector 110 which are arranged in concentric circles, the nozzles 211 of the secondary injector 210 may be arranged in rows and columns.

Meanwhile, the number of nozzles forming the secondary injector 210 may be equal to or smaller than the number of nozzles forming the primary injector 110, and the nozzles of the primary injector 110 and the nozzles of the secondary injector 210 may be configured to have the same diameter.

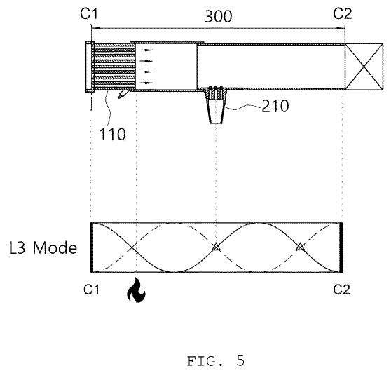

Hereinafter, a design method of an axial multi-stage combustor according to an example of the present disclosure will be specifically described with reference to FIGS. 3 to 5. FIGS. 3 to 5 illustrate an installation position of the secondary injector according to an acoustic field and an acoustic mode according to an example of the present disclosure.

According to an example of the present disclosure, an operation (S300) of arranging the secondary injector 210 may include an operation (S310) of setting an acoustic field of the combustor, an operation (S320) of simulating a pressure fluctuation distribution within the acoustic field, and an operation (S330) of determining an arrangement position of the secondary injector 210 based on the pressure fluctuation distribution.

Specifically, in the operation of setting an acoustic field 300 of the combustor, the acoustic field may be set with a nozzle 111 entrance surface of the primary injector 110 as a front boundary surface C1 and an axial rear end of the second combustion chamber as a rear boundary surface C2.

A flow area of the mixed gas may rapidly decrease at the time of flowing into the nozzle 111, and a choking phenomenon may occur at the nozzle 111 entrance surface. Therefore, a kind of closed system may be formed in which the nozzle 111 entrance surface of the primary injector 110 is the front boundary surface C1 and the axial rear end of the second combustion chamber is the rear boundary surface C2, and in the present disclosure, a region corresponding to the closed system may be set as the acoustic field 300.

When the acoustic field 300 is set, a pressure fluctuation distribution within the acoustic field 300 may be simulated. Here, the pressure fluctuation within the acoustic field 300 refers to a pressure fluctuation when the fuel-air mixture is supplied only from the primary injector 110.

Due to the flames of the first combustion chamber, the mixed gas inside the combustor undergoes a combustion reaction, and when the pressure fluctuation and a heat release rate of the unstable flames constructively interfere with each other, a large acoustic vibration may occur. Therefore, the pressure fluctuation distribution in the acoustic field 300 may be simulated to check a pressure node point PN in the acoustic field 300. At this time, an arrangement position of the secondary injector 210 may be determined as a position corresponding to the pressure node point PN in the acoustic field 300. In other words, the combustor may be designed so that the position of the pressure node point PN in the acoustic field 300 and the position in which the secondary injector 210 is placed in the second combustion liner 200 are the same.

Pressure fluctuation exists at most points in the acoustic field 300, but at the pressure node point PN, pressure fluctuation does not exist or only minimal pressure fluctuation exists. In other words, the pressure node point PN in the acoustic field 300 corresponds to a locally stable point. According to the present disclosure, the secondary injector 210 may be installed at the pressure node point, which is a stable point when the fuel-air mixture is supplied only from the primary injector. By installing the secondary injector 210 at the aforementioned position, the stable point when the fuel-air mixture is supplied only from the primary injector may be changed. That is, by additionally supplying the fuel-air mixture through the secondary injector 210, the state of the stable point may be changed, and ultimately, combustion instability of the combustor 1000 may be reduced.

As described above, according to the present disclosure, the position of the secondary injector 210 may be determined using the pressure node point of the acoustic field, thereby minimizing repeated designs and experiments for developing a combustor and advantageously providing a combustor having a wide range of operating conditions.

In addition, at least one pressure node point may be generated according to a combustion instability acoustic mode of the acoustic field 300, and here, the arrangement position of the secondary injector 210 may be determined as a point corresponding to any one of the pressure node points located at the rear of a nozzle 111 exit surface of the primary injector among the pressure node points.

The first ignition plug 120 described above may be installed on the nozzle 111 exit surface of the primary injector 110, and a primary flame may be provided on the exit surface of the nozzle 111 in which the first ignition plug 120 is installed. That is, the secondary injector 210 may be installed at a point corresponding to one of the pressure node points and may be installed at the rear of the point at which the primary flame is formed.

For example, as shown in FIG. 3, when an acoustic mode of the acoustic field is mode L1, one pressure node point may be generated and the secondary injector 210 may be installed at the corresponding point.

As another example, as shown in FIG. 4, when the acoustic mode of the acoustic field is mode L2, two pressure node points may be generated, and both of the generated pressure node points may be located at the rear end of the primary flame, so that the secondary injector 210 may be installed at a point corresponding to one of the two pressure node points.

As another example, as shown in FIG. 5, when the acoustic mode of the acoustic field is mode L3, three pressure node points are generated. At this time, the pressure node point located most forward among the three generated pressure node points is located in front of the point at which the primary flame is provided, and thus, it is not appropriate for the secondary injector 210 to be disposed at a point corresponding to the corresponding pressure node point and it may be appropriate for the secondary injector 210 to be installed at a point corresponding to one of the remaining two pressure node points.

However, in FIGS. 3 to 5, the pressure fluctuation distribution is only shown as an example for the convenience of description, and the pressure fluctuation distribution of the combustor may be derived through a simulation using a three-dimensional (3D) acoustic modeling technique.

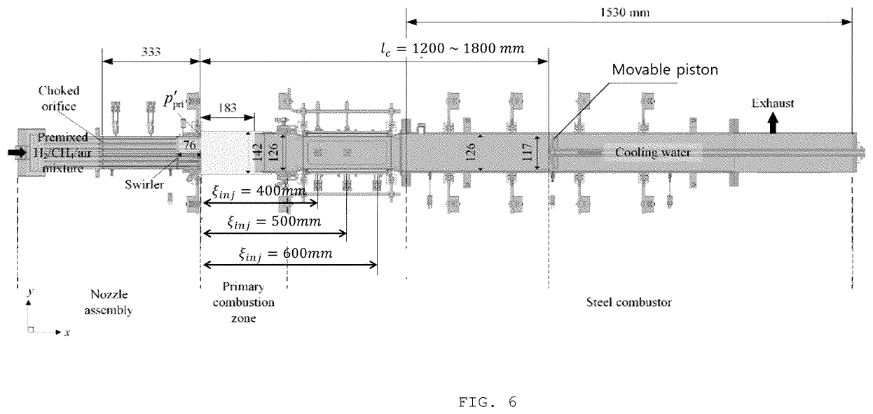

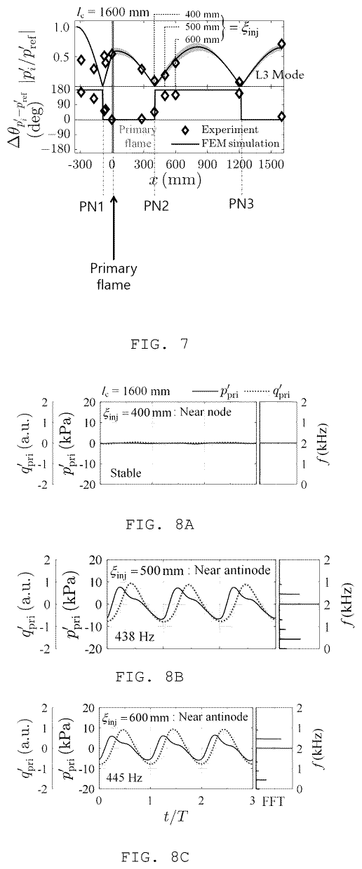

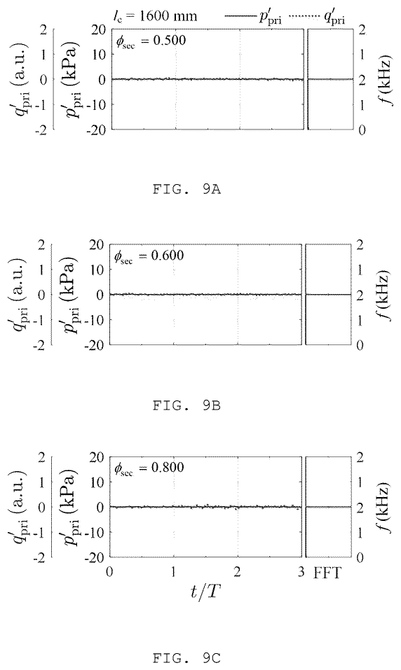

The pressure fluctuation distribution and experimental results of the combustor simulated using the 3D acoustic modeling technique are shown in FIG. 7, and the experimental results for the combustor designed based thereon are shown in FIGS. 8 to 9. FIG. 6 illustrates a tunable combustor rig used in the development of combustors in the actual industrial world, and FIG. 7 illustrates the pressure fluctuations and combustion instability shown by FEM simulation of the tunable combustor using the Comsol Multiphysics program, as well as the actual experimental results (Experiment).

The simulation conditions and experimental conditions are as shown in Table 1 below.

TABLE 1

| | |
|---|---|
| Total length of combustion chamber | 1600 mm |
| Equivalence ratio | 0.6 |
| Fuel composition (hydrogen:methane) | 1:1 |
| Thermal power | 80 kW |

As a result of the simulation under the above conditions, it was confirmed that instability of the third longitudinal mode (mode L3) occurred, and it was confirmed that this was consistent with the actual experimental results. In FIG. 7, the simulation results are shown as solid lines and the experimental results are shown as diamonds, respectively.

Specifically, when the simulation is performed, many acoustic modes may be calculated theoretically, so various modes, such as L1, L2, L3, L4, etc. are calculated, and the natural frequency of the acoustic field when the instability of each mode occurs is calculated. By comparing the frequency of the acoustic field that occurred most frequently in the experiment with the natural frequency calculated in the simulation, it is possible to identify which mode the instability occurred, and it was determined that instability of a third longitudinal mode occurred under the above conditions.

The graph of FIG. 7 illustrates the pressure fluctuation according to the position inside the combustor, which is a pressure fluctuation graph when the nozzle entrance surface of the primary injector 110 corresponds to the −333 mm position and a movable piston of the tunable combustor is located at a point 1600 mm away from the nozzle exit surface of the primary injector 110.

The upper graph is the pressure fluctuation distribution within the entire combustion chamber section according to the position (x-axis) normalized by the pressure fluctuation intensity at the nozzle entrance surface in which the greatest pressure fluctuation occurred, and the lower graph illustrates a phase difference of pressure signals inside the entire combustion chamber when a pressure phase of the first combustion chamber is set to 0 degrees.

As shown in FIG. 7, under the above conditions, the combustor was unstable in the mode L3, and a total of three pressure node points were identified. It was confirmed that one of the two pressure node points located at the rear of the primary flame was generated at a distance of about 400 mm from the primary flame, and the other pressure node point was generated at a distance of about 1200 mm from the primary flame.

FIG. 8A illustrates a pressure fluctuation of an example in which the secondary injector was installed at a point 400 mm away from the primary flame, which corresponds to the pressure node point PN, and FIGS. 8B and 8C are comparative examples illustrating pressure fluctuations when the secondary injector was installed at points 500 mm and 600 mm away from the primary flame, respectively.

As shown in FIG. 8A to FIG. 8C, it can be seen that, when the secondary injector is installed at a point (near node) corresponding to the pressure node point in the acoustic field, the pressure fluctuation distribution of the combustor is stabilized and that, when the secondary injector is installed at a point (near antinode) other than the pressure node point, the pressure fluctuation distribution of the combustor was unstable.

FIG. 9A to FIG. 9C are graphs illustrating pressure fluctuation distributions according to each equivalence ratio in an example in which the total length of the combustion chamber is 1600 mm and the secondary injector is installed at a point corresponding to the pressure node point in the acoustic field. As a result of checking the pressure fluctuation distribution of the combustor while changing the equivalence ratio to 0.500 (FIG. 9A), 0.600 (FIG. 9B), and 0.700 (FIG. 9C), it was confirmed that all have a stable pressure fluctuation distribution.

In this manner, according to an example of the present disclosure, by determining the installation position of the secondary injector 210 by the acoustic field of the combustor, combustion instability of the combustor may be effectively suppressed, and by presenting shape information that enables stable operation at the design stage, the development cost of the combustor due to trial and error may be advantageously reduced. In addition, since a wide operating range may be secured, the present disclosure may contribute to flexible system operation.

Hereinafter, the axial multi-stage combustor 1000 according to an example of the present disclosure will be described. A redundant description will be omitted.

The axial multi-stage combustor 1000 according to an example of the present disclosure may include the first combustion liner 100 defining a first combustion chamber, the second combustion liner 200 defining a second combustion chamber, the primary injector 110 connected to the first combustion liner 100 and supplying a fuel-air mixture to the first combustion chamber, and the secondary injector 210 connected to the second combustion liner and supplying an additional fuel-air mixture to the second combustion chamber.

The position at which the secondary injector 210 is installed in the second combustion liner may be determined by the acoustic field 300 of the combustor. Specifically, the acoustic field may be set with the nozzle 111 entrance surface of the primary injector 110 as the front boundary surface C1 and the axial rear end of the second combustion chamber as the rear boundary surface C2.

The primary injector 110 may be installed at the front end of the first combustion liner 100, and the nozzle 111 of the primary injector 110 may be disposed to be parallel to the axial direction of the first combustion liner 100. The secondary injector 210 is installed on the circumferential surface of the second combustion liner 200, and the nozzle 211 of the secondary injector 210 may be disposed to be perpendicular to the axial direction of the second combustion liner 200.

The secondary injector 210 may be installed at a point corresponding to a pressure node point in the acoustic field 300.

At least one pressure node point may be generated according to the acoustic mode of the acoustic field 300, and the secondary injector 210 may be installed at a point corresponding to any one of the pressure node points located at the rear of the nozzle 111 exit surface of the primary injector 110 among the pressure node points.

As described above, by proposing the design method for a combustor, the present disclosure may provide an advantage of reducing the development cost of a combustor due to trial and error, and at the same time, providing the combustor capable of effectively suppressing combustion instability. In addition, by providing the combustor capable of securing a wide operating range, the present disclosure may contribute to a flexible system operation.

According to an exemplary embodiment of the present disclosure, combustion instability of the combustor may be alleviated.

In addition, the present disclosure may contribute to a flexible system operation by expanding the operating range of the combustor. In addition, repetitive designs and experiments for combustor development may be minimized, thereby reducing the development cost of the combustor.

The effects of the present disclosure are not limited to the effects described above, and effects that are not mentioned may be clearly understood by those skilled in the art from this specification and the attached drawings.

Although the exemplary embodiments of the present disclosure have been described above with reference to the attached drawings, those skilled in the art will understand that the present disclosure may be implemented in other specific forms without changing the technical idea or essential features thereof. Therefore, it should be understood that the exemplary embodiments described above are exemplary in all respects and not restrictive.

### DETAILED DESCRIPTION OF MAIN ELEMENTS

1000: Axial multi-stage combustor
100: First combustion liner
110: Primary injector
111: Nozzle
120: First ignition plug
200: Second combustion liner
210: Secondary injector
211: Nozzle
300: Acoustic field
PN (PN1, PN2, PN3): Pressure node point

What is claimed is:

1. A design method for an axial multi-stage combustor, which is a method of designing a combustor including a first combustion chamber and a second combustion chamber connected in an axial direction, the design method comprising:
defining zones of the first combustion chamber and the second combustion chamber;
disposing a primary injector supplying a fuel-air mixture to the first combustion chamber; and
disposing a secondary injector supplying an additional fuel-air mixture to the second combustion chamber,
wherein the disposing of the secondary injector comprises: setting an acoustic field of the combustor; simulating a pressure fluctuation distribution within the acoustic field; and determining an arrangement position of the secondary injector based on the pressure fluctuation distribution.

2. The design method of claim 1, wherein
the primary injector and the secondary injector each include a plurality of nozzle bundles,
and in the setting of the acoustic field of the combustor, the acoustic field is set with a nozzle entrance surface of the primary injector as a front boundary surface and an axial rear end of the second combustion chamber as a rear boundary surface.

3. The design method of claim 2, wherein
in the disposing of the primary injector, a nozzle of the primary injector is disposed to be parallel to the axial direction of the first combustion chamber, and in the disposing of the secondary injector, a nozzle of the secondary injector is disposed to be perpendicular to the axial direction of the second combustion chamber.

4. The design method of claim 2, further comprising:
checking a pressure node point in the acoustic field; and
determining the arrangement position of the secondary injector as a position corresponding to the pressure node point.

5. The design method of claim 4, further comprising:
determining the arrangement position of the secondary injector as a point corresponding to one of pressure node points arranged at a rear end of a nozzle exit surface of the primary injector, when there are two or more pressure node points checked in the pressure fluctuation distribution.

6. An axial multi-stage combustor including a first combustion chamber and a second combustion chamber connected in an axial direction, the axial multi-stage combustor comprising:
a first combustion liner defining the first combustion chamber;
a second combustion liner defining the second combustion chamber;
a primary injector connected to the first combustion liner and supplying a fuel-air mixture to the first combustion chamber; and
a secondary injector connected to the second combustion liner and supplying an additional fuel-air mixture to the second combustion chamber,
wherein a position in which the secondary injector is installed in the second combustion liner is determined by an acoustic field of the combustor.

7. The axial multi-stage combustor of claim 6, wherein
the primary injector and the secondary injector each include a nozzle bundle including a plurality of nozzles, and the acoustic field has a nozzle entrance surface of the primary injector as a front boundary surface and an axial rear end of the second combustion chamber as a rear boundary surface.

8. The axial multi-stage combustor of claim 7, wherein
the primary injector is installed at a front end of the first combustion liner and a nozzle of the primary injector is disposed to be parallel to the axial direction of the first combustion liner, and the secondary injector is installed on a circumferential surface of the second combustion liner and a nozzle of the secondary injector is disposed to be perpendicular to the axial direction of the second combustion chamber.

9. The axial multi-stage combustor of claim 8, wherein
the secondary injector is installed at a point corresponding to a pressure node point in the acoustic field.

10. The axial multi-stage combustor of claim 9, wherein
at least one pressure node point is generated according to an acoustic mode of the acoustic field, and the secondary injector is installed at a point corresponding to any one of the pressure node points located at a rear of a nozzle exit surface of the primary injector among the pressure node points.
